(19) United States
(12) Patent Application Publication
(10) Pub. No.: US 2014/0112092 A1
(43) Pub. Date: Apr. 24, 2014

(54) Stirring Device Comprising a Stirring Tool and a Drive Motor

(71) Applicant: IKA-Werke GmbH & Co. KG, Staufen (DE)

(72) Inventor: Erhard Eble, Bad Krozingen (DE)

(73) Assignee: IKA-Werke GmbH & Co., KG, Staufen (DE)

(21) Appl. No.: 14/119,346

(22) PCT Filed: Mar. 28, 2012
(86) PCT No.: PCT/EP2012/001367

§ 371 Date: Nov. 21, 2013

(30) Foreign Application Priority Data
May 27, 2011 (DE) 10 2011 102 606.5

(51) Int. Cl. B01F 15/00

(52) U.S. Cl. CPC B01F 15/00538
USPC 366/142; 366/343

(57) ABSTRACT

The invention relates to a stirring device (1) that comprises a stirring tool which can be introduced into a mass or liquid that is to be stirred, a drive motor (4) that drives said stirring tool, a housing (5) enclosing said drive motor (4) and a fastening point (6) for securing said stirring device in a working position. The stirring device (1) has at least one sensor (11) for detecting imbalances which preferably is linked or connected to the open- and closed-loop control systems of the drive motor (4), and which can switch off said drive motor (4) or change the speed thereof in the event of undesired or dangerous oscillations or vibrations.

### CROSS-REFERENCE TO RELATED APPLICATIONS

This application claims priority from PCT/EP2012/001367, filed Mar. 28, 2012, which claims priority from DE 10 2011 102 606.5 filed May 27, 2011, which are hereby incorporated by reference herein in their entireties.

### BACKGROUND OF THE INVENTION

1. Field of the Invention

The invention relates to a stirring device comprising a stirring tool that can be introduced into a mass or liquid to be stirred, a drive motor driving the stirring tool, a housing enclosing the drive motor, and an attachment point for fixing the stirring device in the operating position, particularly for laboratory-related purposes.

2. State of the Art

Such stirring devices are known in a multitude of forms. Above all, such stirring devices for laboratory use are often fixed to a stand, but such stirring devices with another manner of support or storage are also known.

Oftentimes, the shaft emerging from the housing of the stirring device is relatively long, and the stirring tool is generally stored in an overhung position. Depending on the material and mass to be stirred, and depending on manufacturing tolerances, this can lead to vibrations or to an imbalance on the rotating parts and particularly at the stirring tool as well, which can be dangerous above all in the case of relatively long shafts or stirrers and especially if the stirring tool dips into a glass vessel. Imbalance can cause the glass vessel to be contacted on the interior by the stirring tool and possibly even destroyed.

### SUMMARY OF THE INVENTION

It is therefore the object to provide a stirring device of the type defined at the outset in which the danger of damage or destruction of parts involved in the stirring process is reduced or prevented.

To achieve this object, a provision is made according to the invention that the stirring device has a sensor that responds to imbalance. As a result, it is possible to detect vibrations or imbalance occurring on the stirring device in a timely manner and to take appropriate action.

One expedient embodiment can consist of the sensor that is responsive to imbalance being an acceleration sensor. Acceleration sensors are inherently known and can be obtained inexpensively and easily mounted on or in the stirring device.

It can be expedient if the sensor is provided with an acoustic and/or optical display or signal device or controls such a device.

In this way, the user of the stirring device can be warned acoustically or optically if excessive imbalance occurs.

It is particularly favorable if the sensor that is responsive to imbalance is connected to the control of the drive motor and changes, namely decreases or increases, the speed of the drive motor upon overshooting of a threshold or switches the drive motor off. Automatic prevention or even elimination of damage caused by imbalance can therefore be achieved through such a configuration.

The sensor can be arranged on the housing of the stirring device and/or on at least one printed circuit board arranged in the housing, for example on the printed circuit board being used for the open-loop control or feedback control of the drive motor and/or on the printed circuit board being used for the power supply of the drive motor. As a result, the sensor can be integrated directly into the corresponding power circuit and connected thereto.

In one modified embodiment, a provision can be made that the sensor for detecting an imbalance is arranged on the outer surface or on the inner surface of the housing wall of the housing enclosing the drive motor and is connected to the open-loop control or feedback control of the drive motor. Particularly, the vibrations occurring as a result of manufacturing tolerances or the weight of the material being stirred are transferred to the housing, so that the abovementioned arrangement of the sensor on the housing itself is to be regarded as a simple and possibly subsequently executable for achieving the object described above.

Another possibility in this respect that can be provided in addition to or in place of the possibilities described above consists in arranging the sensor on the holder of the stirring device.

In one expedient arrangement particularly of the sensor, a provision can be made that it is piezo-based or inductive with plunger or embodied by means of deflectable mass or by means of a strain gauge. Sensors configured in this manner have proven their worth in the detection of imbalance or vibrations, so that a commensurate use constitutes an inexpensive solution for the stirring device according to the invention.

Especially the combination of individual or several of the features and measures described above results in a stirring device in which the consequences of vibrations or imbalance can be detected in a timely manner and thus mitigated or prevented.

### BRIEF DESCRIPTION OF THE DRAWINGS

In the following, an exemplary embodiment is described in further detail with reference to the drawing. In partially schematic illustration:

FIG. 1 shows a front view,

FIG. 2 shows a side view held partially in the longitudinal section,

FIG. 3 shows a rear view, and

FIG. 4 shows a top view of a stirring device according to the invention with a drive motor that drives a stirring tool that is not shown and not coupled.

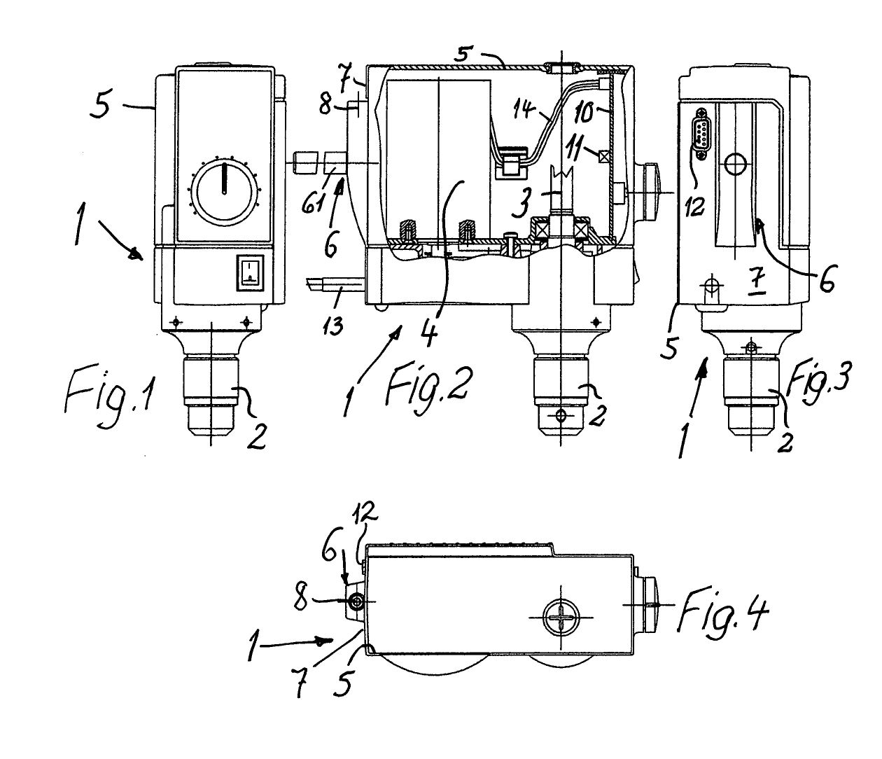

### DETAILED DESCRIPTION OF THE PREFERRED EMBODIMENTS

A stirring device designated throughout with 1 is provided for the purpose of stirring a mass or liquid into which a stirring tool can be introduced. The stirring tool can be coupled with a chuck 2 which, in turn, is connected via a shaft 3 to a drive motor 4, so that, after introduction of a stirring tool into the chuck 2, stirring can be performed by switching this drive motor 4 on.

The drive motor 4 is accommodated in a housing 5 enclosing it on whose outer surface an attachment point 6 is provided for fixing the stirring device 1 in the operating position. In the exemplary embodiment, one can see, as an attachment point 6 on the rear wall 7 of the housing 5, a console 9 provided with an attachment screw 8 which enables the plugging-on of the stirring device 1 with this attachment point 6 onto a horizontal arm 61 of a stand.

Especially when a relatively long stirrer shaft is mounted on the chuck 2 and/or when there are relatively generous manufacturing tolerances, an imbalance of the stirring tool and its shaft can occur, thus leading to oscillations and vibrations on and in the stirring device 1.

In order to detect such undesired phenomena in a timely manner, a sensor 11 that responds to imbalance or a vibration sensor 11 is provided according to FIG. 2 on a printed circuit board 10 arranged in the housing 5 of the stirring device 1. This can be arranged on the printed circuit board 10 being used for the open-loop control or feedback control of the drive motor 4 or for the power supply of the drive motor 4 and integrated into the circuit.

Visible on the rear wall 7 is also an interface 12 and a cable 13 for supplying power or current, as well as lines 14 to the printed circuit board 10 on the interior surface.

The sensor 11 can be piezo-based or inductive with plunger or embodied by means of deflective mass or by means of a strain gauge and be commercially available, for example. It should also be mentioned that more than one sensor 11 could also optionally be provided.

The stirring device 1 with a stirring tool that can be introduced into a mass or liquid to be stirred, with a drive motor 4 driving the stirring tool, with a housing 5 enclosing the drive motor 4, and with an attachment point 6 for fixing the stirring device 1 in the operating position has at least one sensor 11 that responds to imbalance and that is preferably connected to or interconnected with the open-loop control or the feedback control of the drive motor 4 and capable of switching the drive motor 4 off in the event of undesired or dangerous oscillations or vibrations or changing its speed.

1. Stirring device (1) comprising a stirring tool that can be introduced into a mass or liquid to be stirred, comprising a drive motor (4) driving the stirring tool, comprising a housing enclosing the drive motor (4), and comprising an attachment point (6) for fixing the stirring device (1) in the operating position, characterized in that the stirring device (1) has a sensor (11) that responds to imbalance.

2. Stirring device as set forth in claim 1, characterized in that the sensor that responds to imbalance is an acceleration sensor.

3. Stirring device as set forth in claim 1, characterized in that the sensor (11) (i) is provided with at least one of an acoustic display and an optical display, and a signal device or, (ii) controls such a display or device.

4. Stirring device as set forth in claim 1, characterized in that the sensor (11) that responds to imbalance is connected to an open-loop control or a feedback control of the drive motor (4) to one of (i) changes, the speed of the drive motor (4) upon overshooting of a threshold Of and (ii) switches the drive motor (4) off.

5. Stirring device as set forth in claim 1, characterized in that the sensor (11) is arranged on at least one of the housing (5) of the stirring device (1) and on at least one printed circuit board (10) arranged in the housing (5).

6. Stirring device as set forth in claim 4, characterized in that the sensor (11) for detecting an imbalance is arranged on one of the outside surface and the inside surface of the housing wall of the housing (5) enclosing the drive motor (4) and is connected to one of the open-loop control or and the feedback control of the drive motor (4).

7. Stirring device as set forth in claim 1, characterized in that the sensor (11) is arranged on the holder of the stirring device.

8. Stirring device as set forth in claim 1, characterized in that the sensor (11) is at least one of (i) piezo-based, inductive with plunger, and (iii) embodied by means of deflectable mass or by means of a strain gauge.
